(19) United States
(12) Patent Application Publication
(10) Pub. No.: US 2014/0070955 A1
(43) Pub. Date: Mar. 13, 2014

(54) System and method for sending a visual notification from a stage performer to an audio engineer

(71) Applicant: Derek Brener, Hollywood, CA (US)

(72) Inventors: Derek Brener, Hollywood, CA (US); Kelsey Gingrich, Lititz, CA (US)

(73) Assignee: Derek Brener, Hollywood, CA (US)

(21) Appl. No.: 14/023,653

(22) Filed: Sep. 11, 2013

Related U.S. Application Data
(60) Provisional application No. 61/699,775, filed on Sep. 11, 2012.

(51) Int. Cl. G08B 5/36

(52) U.S. Cl. CPC G08B 5/36
USPC 340/815.45; 340/815.48

(57) ABSTRACT

A system and method for sending a visual notification from a stage performer to an audio engineer. When a performer requires the attention of an audio engineer, she activates a switch that transmits a signal to a light board via standard stage cabling. Multiple performer positions can be run through a single light board. In fact, performer stations can be daisy chained together for a more efficient configuration.

### CROSS REFERENCE TO RELATED APPLICATIONS

This application claims the benefit of U.S. Provisional Patent App. No. 61699775 filed on Sep. 11, 2012, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

Field of the invention: This invention relates to the general field of stage productions, and more specifically toward a system and method for sending a visual notification from a stage performer to an audio engineer. When a performer requires the attention of an audio engineer, she activates a switch that transmits a signal to a light board via standard stage cabling. Multiple performer positions can be run through a single light board. In fact, performer stations can be daisy chained together for a more efficient configuration.

There is something special about watching a live performance; something that is not translated when watching or listing to a previously recorded concert or stage production. Each show is unique, often times because of subtle differences or imperfections in the performer, venue, and technical crew, including the audio engineer. While these small changes enhance the allure of live performances, larger errors can be distracting to the audience and performers. For example, a performer's monitor (a speaker that projects towards the performer) may be too soft, meaning that the performer is unable to hear her accompanists, or may be too loud, making it hard for her to hear anything else, including herself. Another example is when the audio engineer has inadvertently left off a vocalist's microphone. These errors not only inconvenience the performer, but also degrade the overall performance put on for the audience. To correct this issue during a live performance, the performer must get the attention of the audio engineer in an attempt to rectify the problem during the show.

During a live performance, however, it is often difficult for the musicians to get the attention of the audio engineer for many reasons. For example, there can be sightline issues, where opaque objects reside between the audio engineer and the performer. Another example is when the audio engineer is busy with other tasks and does not notice a struggling performer on stage. The performer cannot stop what they are doing and call out the audio engineer's name, nor can the performer make wild gestures in an attempt to visually get the attention of the audio engineer. Thus, the performer is sometimes required to tolerate an inconvenient, uncomfortable, or otherwise less than perfect situation. This can lead to a very frustrating show for a performer and the threat of being fired as the audio engineer.

Thus there has existed a long-felt need for a system and method for gaining the attention of an audio engineer by a performer in an efficient and discreet manner.

### SUMMARY OF THE INVENTION

The current invention provides just such a solution by having a system and method for sending a visual notification from a stage performer to an audio engineer. When a performer requires the attention of an audio engineer, she activates a switch that transmits a signal to a light board via standard stage cabling. Multiple performer positions can be run through a single light board unit. In fact, performer stations can be daisy chained together for a more efficient configuration.

The current invention is intended for communication between the audio engineer and performers in a live concert performance, though the current invention can also be used in a variety of live performance environments, including without limitation recording studios, political conventions, corporate events, and television and movie sets. It is used so that the performers are able to get the visual or auditory attention of whoever is controlling their monitor mix, such as the audio engineer. Once the performer has the audio engineer's attention, she can communicate whatever requests she may have using a different means of communication, such as hand signals.

In a particular embodiment, the current invention will be comprised of a rack mountable base unit which can be rack mounted, sit upon the doghouse on the soundboard/console, or otherwise be positioned such that it is visible to the audio engineer and will serve as a base for multiple triggers that occupy various positions on stage. The front of the base unit has eight variable intensity light emitting diode (LED) lights, each with a distinct color. The LED's are labeled 1 through 8 or Mix 1 through 8 to represent each mix position, performers mix, or footswitch on stage. The LED's have a low-intensity to high-intensity variable switch to vary the brightness of the LED's. On the back of the base unit are eight 3-pin male XLR connections in banks of four. Also, two 5-pin XLR connections are included, each next to a bank of 3-pin XLR, to give the audio crew the capability to run less cable and to use a selectable address option (jump from footswitch to footswitch).

In addition to visual indicators (LEDs) on the base unit, an audio indicator may be incorporated as well. A speaker can produce a noise, such as a beep, when a channel (or any channel) is activated. A volume control knob may be integrated in the base unit to vary the volume at which the speaker emits a sound, such as a beep, when a channel is activated. In this manner, the attention of the audio engineer may be captured even though he does not notice any of the illuminated lights on the base unit.

Onstage, each mix position, monitor wedge, IEM (in ear monitor), performer, tech, or whoever it may be, is tied to a footswitch, or simply a notification switch. Each footswitch includes a button (switch) to trigger the corresponding mix light at the base unit, a knob (position) selector to choose the address of the corresponding mix, a male and female 5-pin XLR for jumping the footswitches together, and a female 3-pin XLR option to homerun the footswitch (run a cable straight to the base unit without jumping to another footswitch). Other options can be implemented to trigger the base unit LED's as well such as a drum pad, etc. These footswitches/triggers can also be wireless, though one advantage of the aforementioned embodiment is to use the same type of cables used by audio engineers and will not interfere with or be interfered by other wireless transmissions, including those of wireless microphones used on stage.

When a footswitch is depressed or otherwise activated, it causes an electrical signal to be sent to the base unit to light up the corresponding LED. In a particular embodiment, the LED light blinks 5 times. In another embodiment, the LED light blinks while the footswitch is depressed. In yet another embodiment, the LED light begins blinking once the footswitch has been depressed, and continues blinking until reset by the audio engineer. Once the engineer notices which light is blinking, he will refer to the corresponding mix position on stage. The performer and engineer will make eye contact and be able to communicate.

A purpose of this invention is to improve the communication between performer and audio engineer by making it easier for performers to timely inform the audio engineer of their audio or other needs.

It is a principal object of the invention to provide an efficient means of a stage performer gaining the attention of an audio engineer.

It is another object of the invention to provide a system and method of notifying an audio engineer using standard audio cabling and connectors.

It is a further object of this invention to provide a system and method that enables a stage performer to quickly and discreetly gain the attention of an engineer.

As used herein, “audio engineer” shall include without limitation mixer, monitor or front of house audio engineer, and other audio crew; button and switch are devices for making and breaking the connection in an electric circuit.

An embodiment of the current invention is a system comprising a base unit and a plurality of footswitches, where the base unit comprises two five-pin XLR connectors, eight three-pin XLR connectors, and eight lights, where each footswitch comprises a five-pin female XLR connector, a five-pin male XLR connector, a three-pin female XLR connector, a position selector, and a switch. This embodiment may be configured such that each footswitch is connected to the base unit directly via XLR cabling or at least one of the plurality of footswitches is connected to the base unit indirectly via another footswitch and XLR cabling. Activating the switch or button of a footswitch causes one of the eight lights of the base unit to illuminate, wherein the lights of the base unit comprise light emitting diodes. The position selector of each footswitch has four positions.

Another embodiment of the current invention is a method comprising the steps of connecting a footswitch to a base unit, where the base unit comprises a five-pin XLR connector, a plurality three-pin XLR connectors, and a plurality lights, where the footswitch comprises a five-pin female XLR connector, a five-pin male XLR connector, a three-pin female XLR connector, a position selector, and a switch; depressing the switch thereby causing one of the plurality of lights of the base unit to illuminate. Further steps may include connecting a second footswitch to the base unit, where the second footswitch comprises a five-pin female XLR connector, a five-pin male XLR connector, a three-pin female XLR connector, a position selector, and a switch; or connecting a second footswitch to the footswitch, where the second footswitch comprises a five-pin female XLR connector, a five-pin male XLR connector, a three-pin female XLR connector, a position selector, and a switch. The method may also include setting the position selector of the footswitch to a first position; and setting the position selector of the second footswitch to a second position.

Yet another embodiment of the current invention is a system comprising a base unit and a notification switch, where the base unit comprises a plurality of five-pin XLR connectors, a plurality of three-pin XLR connectors, and a plurality of lights, where the notification switch comprises a five-pin female XLR connector, a five-pin male XLR connector, a three-pin XLR connector, a position selector, and a button. The notification switch may be connected to the base unit directly via XLR cabling. A second notification switch may also be, where the second notification switch comprises a five-pin female XLR connector, a five-pin male XLR connector, a three-pin XLR connector, a position selector, and a button. The second notification switch can be connected to the base unit directly via XLR cabling; or the second notification switch is connected to the notification switch, which in turn is connected to the base unit. The system may further comprise a third notification switch, where the third notification switch comprises a five-pin female XLR connector, a five-pin male XLR connector, a three-pin XLR connector, a position selector, and a button, and where the notification switch and second notification switch are each directly connected to the base unit, and where the third notification switch is connected to the second notification switch. Activating the button of the notification switch causes one of the plurality of lights of the base unit to illuminate, the plurality of lights of the base unit each comprise a light emitting diode, and/or the position selector of the notification switch has four positions.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a front top perspective view of a footswitch according to selected embodiments of the current disclosure.

FIG. 2 is a schematic view of electrical connections of a footswitch according to selected embodiments of the current disclosure.

FIG. 3 is a diagram of a base unit, multiple footswitches, and the connections therebetween according to selected embodiments of the current disclosure.

FIG. 4 is a top view of a stage with performers using a system and method according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

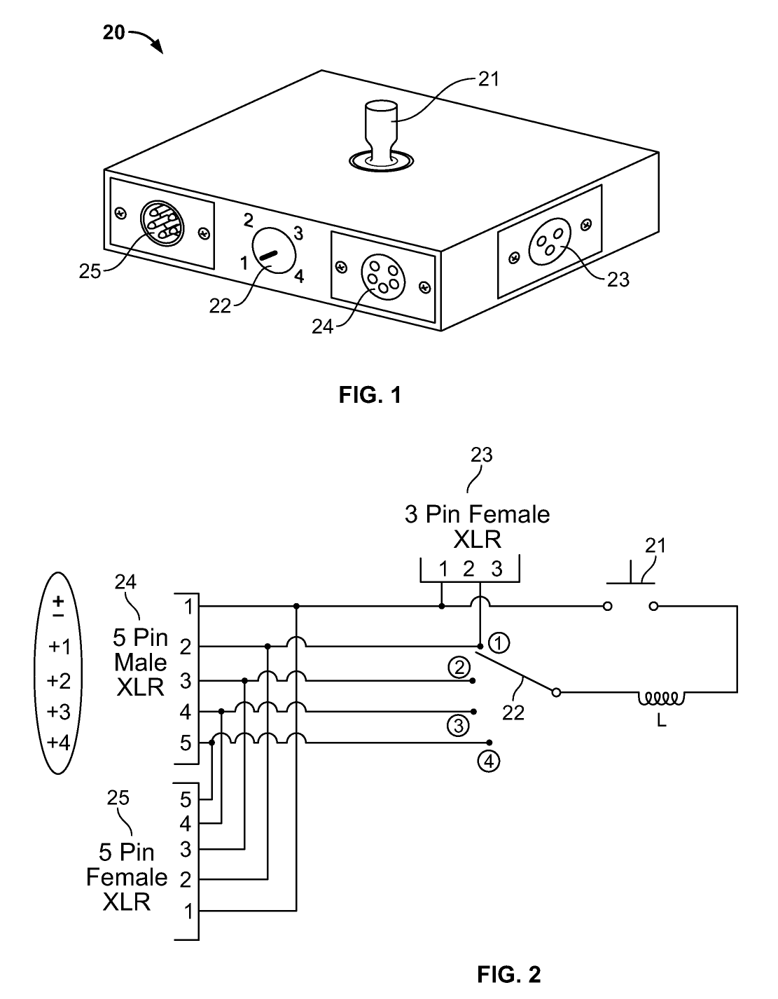

FIG. 1 is a front top perspective view of a footswitch according to selected embodiments of the current disclosure. A footswitch 20 includes a switch 21 that may be depressed by a performer. The sides of the footswitch 20 include a three-pin female XLR connector 23, a five-pin male XLR connector 24, a five-pin female XLR connector, and a position selector 22. Described in more detail below, the position selector is a four-way pin select that selects the pin position for that particular footswitch.

FIG. 2 is a schematic view of electrical connections of a footswitch according to selected embodiments of the current disclosure. A switch 21 is used to complete a circuit. The circuit that is completed depends upon the XLR connector used to connect to the base unit (not shown in this figure) and position selector 22. As shown in this figure, the position selector 22 selects between pins two through five. When using the three-pin female XLR connector 23, the position selector should be in the first position, which selects the second pin. Thus, when the switch 21 is depressed, a circuit including the second pin is completed and thus lights up the position in the base unit that this footswitch is connected directly or indirectly to. For example, if this footswitch is connected to the fourth three-pin female XLR connection on the base unit, the fourth position would light up on the base unit when the switch is depressed. As can be seen from this figure, one of the five pins of the five-pin XLR connector is a ground connection, while the remaining four pins are different channels that can be used by different foot switches depending upon the selection of the position indicator. In a particular embodiment, the position selector 22 is a rotatable knob. In another embodiment, the position selector 22 is four-way switch. In yet another embodiment, the position selector 22 is a rotatable recessed switch.

When the five-pin female XLR connector 25 is used to connect the footswitch to the base unit, either directly or via another footswitch, the position selector 22 determines which pin is used. As position selector 22 is moved from the first through fourth position, it connects the circuit to pins two through five. Thus, if position selector 22 is in the third position, the fourth pin would be selected. By connecting this footswitch via five-pin XLR to the first five-pin XLR of the base unit, depressing the switch of the footswitch would result in the third position of the base unit lighting up. Subsequent footswitches connect from their female XLR connector to the male XLR connector 24.

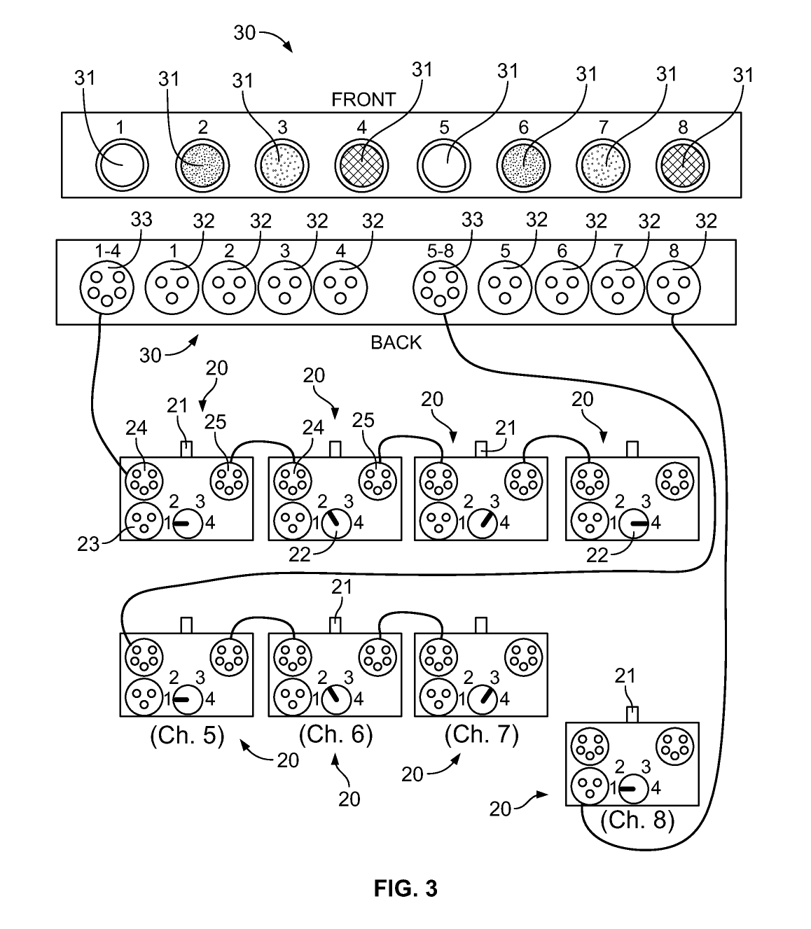

FIG. 3 is a diagram of a base unit, multiple footswitches, and the connections therebetween according to selected embodiments of the current disclosure. The front of the base unit 30 includes a plurality of LED lights 31; in this configuration, there are eight. On the backside of the base unit 30, there are two five-pin male XLR 33 connectors and eight three-pin male XLR connectors 32 separated into two groups, each with one five-pin male XLR connector and four three-pin male XLR connectors. In this configuration, four footswitches 20 are daisy chained together using five-pin male XLR connectors 24 and five-pin female XLR connectors 25, which are then in turn connected to a five-pin male XLR connector in the base unit 30. Each of the four footswitches has a different position selected by the position selector 22, such that each footswitch operates on a different channel through the five-pin XLR connectors. Furthermore, there are three additional footswitches 20 connected via five-pin XLR connectors to the second five-pin male XLR connector 33 of the base unit 30. Finally, another footswitch 21 is connected to one of the eight three-pin XLR connectors 32 of the base unit via a direct or “home run” connection.

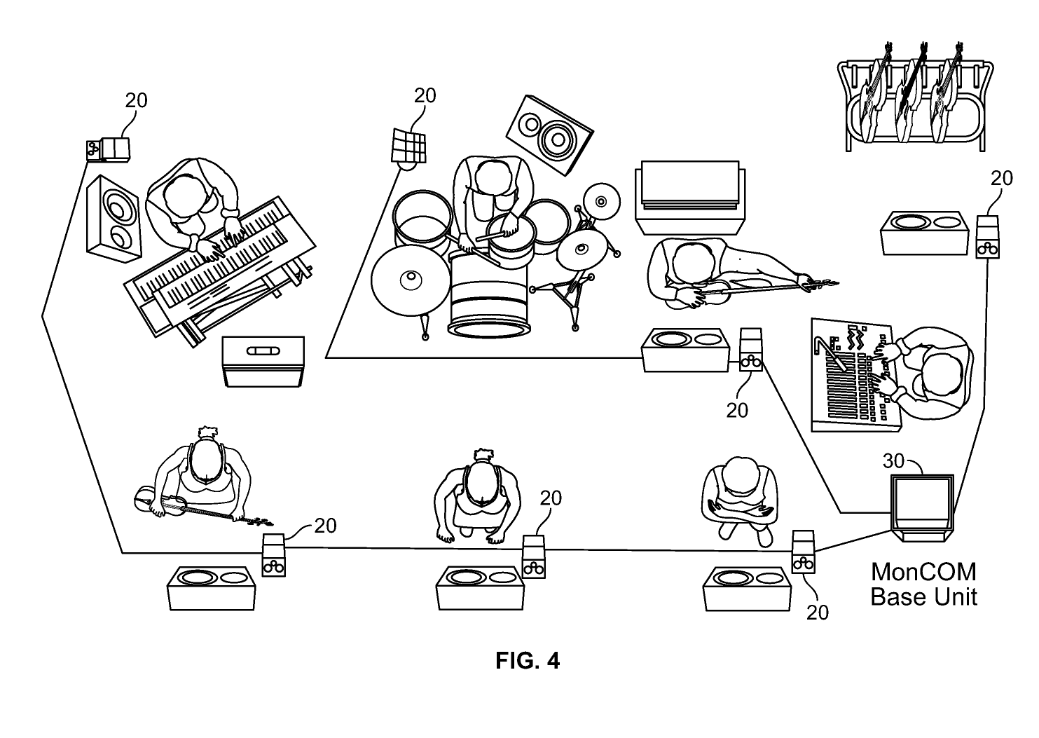

FIG. 4 is a top view of a stage with performers using a system and method according to selected embodiments of the current disclosure. The footswitches 20 are connected to the base unit 30. A user may use standard stage XLR cabling with both three-pin and five-pin XLR connectors. In this particular embodiment, footswitches 20 are daisy chained together and then secured to the base unit 30 using five-pin XLR connectors with each footswitch having the position selector in a different position. Two Footswitches 20 are daisy chained together as well to connect to the base unit 30. Finally, a lone footswitch 20 is connected to the base unit 30, preferably by a three-pin XLR connector cable.

There may be occasions where more than eight performers on a stage will require their own footswitch. In these instances, a base unit could be manufactured with more than 8 positions. Another solution includes overloading a single position, whereby multiple footswitches are assigned to the same channel or position. In this scenario, the depression of one or more of the switches on a particular channel would cause that position to light up on the base unit. The audio engineer then needs to determine which performer of a group of performers requires his attention by, for example, making eye contact with each of the group of performers until the appropriate performer is located and communication is commenced. In this manner, sixteen performers may each have their own footswitch, where the performers are grouped together with an average of two performers per channel. When a base unit indicator light illuminates, the audio engineer would then only need to check which of the two performers requires his attention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

That which is claimed:

1. A system comprising
a base unit and a plurality of footswitches,
where the base unit comprises two five-pin XLR connectors, eight three-pin XLR connectors, and eight lights,
where each footswitch comprises a five-pin female XLR connector, a five-pin male XLR connector, a three-pin female XLR connector, a position selector, and a switch.

2. The system of claim 1, whereby each footswitch is connected to the base unit directly via XLR cabling.

3. The system of claim 1, whereby at least one of the plurality of footswitches is connected to the base unit indirectly via another footswitch and XLR cabling.

4. The system of claim 1, whereby activating the switch of a footswitch causes one of the eight lights of the base unit to illuminate.

5. The system of claim 1, wherein the lights of the base unit comprise light emitting diodes.

6. The system of claim 1, wherein the position selector of each footswitch has four positions.

7. A method comprising the steps of
connecting a footswitch to a base unit, where the base unit comprises a five-pin XLR connector, a plurality three-pin XLR connectors, and a plurality lights, where the footswitch comprises a five-pin female XLR connector, a five-pin male XLR connector, a three-pin female XLR connector, a position selector, and a switch;
depressing the switch thereby causing one of the plurality of lights of the base unit to illuminate.

8. The method of claim 7, where the footswitch is connected directly to the base unit using XLR cabling.

9. The method of claim 7, further comprising the step of connecting a second footswitch to the base unit, where the second footswitch comprises a five-pin female XLR connector, a five-pin male XLR connector, a three-pin female XLR connector, a position selector, and a switch.

10. The method of claim 7, further comprising the step of connecting a second footswitch to the footswitch, where the second footswitch comprises a five-pin female XLR connector, a five-pin male XLR connector, a three-pin female XLR connector, a position selector, and a switch.

11. The method of claim 10, further comprising the steps of
setting the position selector of the footswitch to a first position; and
setting the position selector of the second footswitch to a second position.

12. A system comprising
a base unit and a notification switch,
where the base unit comprises a plurality of five-pin XLR connectors, a plurality of three-pin XLR connectors, and a plurality of lights,
where the notification switch comprises a five-pin female XLR connector, a five-pin male XLR connector, a three-pin XLR connector, a position selector, and a button.

13. The system of claim 12, whereby the notification switch is connected to the base unit directly via XLR cabling.

14. The system of claim 12, further comprising a second notification switch, where the second notification switch comprises a five-pin female XLR connector, a five-pin male XLR connector, a three-pin XLR connector, a position selector, and a button.

15. The system of claim 14, wherein the second notification switch is connected to the base unit directly via XLR cabling.

16. The system of claim 14, wherein the second notification switch is connected to the notification switch, which in turn is connected to the base unit.

17. The system of claim 14, further comprising a third notification switch, where the third notification switch comprises a five-pin female XLR connector, a five-pin male XLR connector, a three-pin XLR connector, a position selector, and a button,
where the notification switch and second notification switch are each directly connected to the base unit, and where the third notification switch is connected to the second notification switch.

18. The system of claim 12, whereby activating the button of the notification switch causes one of the plurality of lights of the base unit to illuminate.

19. The system of claim 12, wherein the plurality of lights of the base unit each comprise a light emitting diode.

20. The system of claim 12, wherein the position selector of the notification switch has four positions.
